(19) United States
(12) Patent Application Publication
(10) Pub. No.: US 2012/0176913 A1
(43) Pub. Date: Jul. 12, 2012

(54) APPARATUS AND METHOD FOR FREQUENCY OFFSET ESTIMATION FOR HIGH SPEED IN BROADBAND WIRELESS ACCESS SYSTEM

(75) Inventors: Yon-Woo Yoon, Anyang-si (KR); Hee-Won Kang, Seongnam-si (KR)

(73) Assignee: SAMSUNG ELECTRONICS CO., LTD., Suwon-si (KR)

(21) Appl. No.: 13/349,445

(22) Filed: Jan. 12, 2012

(30) Foreign Application Priority Data
Jan. 12, 2011 (KR) 10-2011-0002952

(51) Int. Cl. H04W 24/00; H04L 12/26

(52) U.S. Cl. 370/242

(57) ABSTRACT

An apparatus and method estimate frequency offset for high speed in a wireless access system. An operation of a Base Station (BS) includes performing feedback channel detection for a terminal classified as a low speed mode, and, if the feedback channel detection fails continuously by the predefined number of times, and a frequency offset estimation result using a pilot signal exceeds a threshold value, classifying the terminal as a high speed mode.

### CROSS-REFERENCE TO RELATED APPLICATION(S) AND CLAIM OF PRIORITY

The present application is related to and claims the benefit under 35 U.S.C. §119(a) to a Korean patent application filed in the Korean Intellectual Property Office on Jan. 12, 2011 and assigned Serial No. 10-2011-0002952, the entire disclosure of which is hereby incorporated by reference.

### TECHNICAL FIELD OF THE INVENTION

The present disclosure relates to frequency offset estimation in a broadband wireless access system.

### BACKGROUND OF THE INVENTION

In the 4^{th} Generation (4G) communication system, which is the next generation communication system, intensive research is being conducted to provide users with services of various Qualities of Service (QoS) at a data rate of about 100 Mega bits per second (Mbps). In particular, a study of the 4 G communication system is now made to support high-speed services in the way of guaranteeing mobility and QoS for a Broadband Wireless Access (BWA) communication system such as a Wireless Local Area Network (WLAN) system and a Wireless Metropolitan Area Network (WMAN) system. Also, the typical 4 G communication system is an Institute of Electrical and Electronics Engineers (IEEE) 802.16 system.

The IEEE 802.16 system employs an Orthogonal Frequency Division Multiplexing/Orthogonal Frequency Division Multiple Access (OFDM/OFDMA) scheme in a physical layer. The OFDM/OFDMA scheme is a technology capable of supporting the use efficiency of high frequency band and a transmission rate. However, the OFDM/OFDMA scheme is so sensitive to a frequency offset. Accordingly, when the frequency offset exists, it gets difficult to maintain orthogonality between subcarriers, so performance is seriously deteriorated.

On the other hand, a Doppler frequency generated by the frequency offset and a movement of a terminal induces a channel variation dependent on time, thereby making channel estimation difficult. By estimating the frequency offset and compensating for the frequency offset before channel estimation, channel estimation performance can be improved. In a case of an OFDM system in which a pilot pattern exists within a tile structure, a frequency offset can be generally estimated from a phase difference of pilot signals.

An estimable range of a frequency offset is decided depending on a symbol interval of two pilot signals used for phase difference measurement. The faster a movement speed of a terminal is the greater a size of the frequency offset is. So, as the movement speed gets faster, even more the pilot signals are required. Accordingly, a separate technique for estimating a frequency offset for a terminal moving at high speed is required. At this time, it is expected that the frequency offset estimation technique for the terminal moving at high speed would be complex compared to a frequency offset estimation technique for a terminal moving at low speed. So, for the sake of efficient system resource management, a technique for first determining if a movement of a terminal is a high speed or low speed is also required.

Proposed should be an alternative for determining a high speed or low speed movement of a terminal and, according to the determination result, applying a suitable frequency offset estimation technique in an OFDM/OFDMA based broadband wireless access system as described above.

### SUMMARY OF THE INVENTION

To address the above-discussed deficiencies of the prior art, it is a primary aspect of the present disclosure to provide an apparatus and method for determining a high speed or low speed movement of a terminal in a broadband wireless access system.

Another aspect of the present disclosure is to provide an apparatus and method for determining a high speed or low speed movement of a terminal using a success or failure of detection of a feedback channel in a broadband wireless access system.

A further aspect of the present disclosure is to provide an apparatus and method for estimating a frequency offset for a terminal moving at high speed in a broadband wireless access system.

The above aspects are achieved by providing an apparatus and method for frequency offset estimation for high speed in a broadband wireless access system.

According to one aspect of the present disclosure, an operation method of a Base Station (BS) in a broadband wireless access system is provided. The method includes performing feedback channel detection for a terminal classified as a low speed mode, and, if the feedback channel detection fails continuously by the predefined number of times, and a frequency offset estimation result using a pilot signal exceeds a threshold value, classifying the terminal as a high speed mode.

According to another aspect of the present disclosure, a BS apparatus in a broadband wireless access system is provided. The apparatus includes a detector for performing feedback channel detection for a terminal classified as a low speed mode, and a mode manager for, if the feedback channel detection fails continuously by the predefined number of times, and a frequency offset estimation result using a pilot signal exceeds a threshold value, classifying the terminal as a high speed mode.

Other aspects, advantages, and salient features of the invention will become apparent to those skilled in the art from the following detailed description, which, taken in conjunction with the annexed drawings, discloses exemplary embodiments of the invention.

Before undertaking the DETAILED DESCRIPTION OF THE INVENTION below, it may be advantageous to set forth definitions of certain words and phrases used throughout this patent document: the terms “include” and “comprise,” as well as derivatives thereof, mean inclusion without limitation; the term “or,” is inclusive, meaning and/or; the phrases “associated with” and “associated therewith,” as well as derivatives thereof, may mean to include, be included within, interconnect with, contain, be contained within, connect to or with, couple to or with, be communicable with, cooperate with, interleave, juxtapose, be proximate to, be bound to or with, have, have a property of, or the like; and the term “controller” means any device, system or part thereof that controls at least one operation, such a device may be implemented in hardware, firmware or software, or some combination of at least two of the same. It should be noted that the functionality associated with any particular controller may be centralized or distributed, whether locally or remotely. Definitions for certain words and phrases are provided throughout this patent document, those of ordinary skill in the art should understand that in many, if not most instances, such definitions apply to prior, as well as future uses of such defined words and phrases.

### BRIEF DESCRIPTION OF THE DRAWINGS

For a more complete understanding of the present disclosure and its advantages, reference is now made to the following description taken in conjunction with the accompanying drawings, in which like reference numerals represent like parts:

FIG. 1 illustrates a structure of a feedback channel in a broadband wireless access system according to an exemplary embodiment of the present disclosure;

FIG. 2 illustrates a pilot signal pair for frequency offset estimation in a broadband wireless access system according to an exemplary embodiment of the present disclosure;

FIG. 3 illustrates a virtual pilot signal pair for frequency offset estimation in a broadband wireless access system according to an exemplary embodiment of the present disclosure;

FIG. 4 illustrates a state transition diagram in a broadband wireless access system according to an exemplary embodiment of the present disclosure;

FIG. 5 illustrates an operation procedure of a Base Station (BS) in a broadband wireless access system according to an exemplary embodiment of the present disclosure; and

FIG. 6 illustrates a block diagram of a BS in a broadband wireless access system according to an exemplary embodiment of the present disclosure.

Throughout the drawings, like reference numerals will be understood to refer to like parts, components and structures.

### DETAILED DESCRIPTION OF THE INVENTION

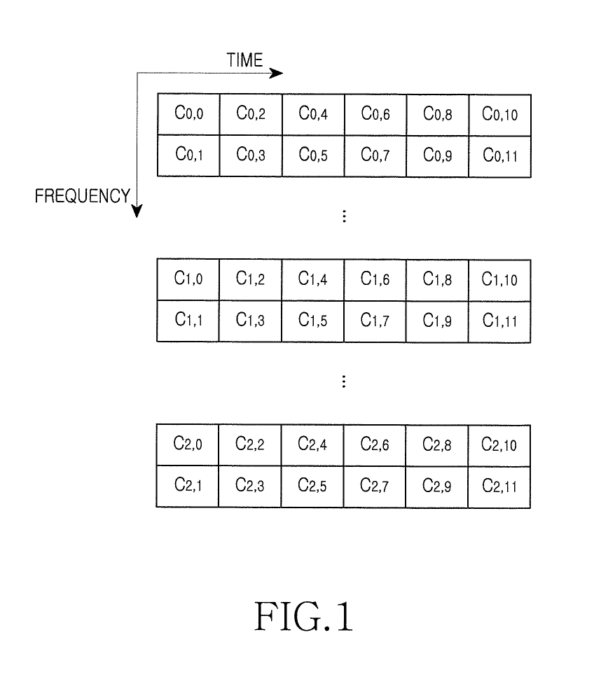

FIGS. 1 through 6, discussed below, and the various embodiments used to describe the principles of the present disclosure in this patent document are by way of illustration only and should not be construed in any way to limit the scope of the disclosure. Those skilled in the art will understand that the principles of the present disclosure may be implemented in any suitably arranged wireless communications system

Preferred embodiments of the present invention will be described herein below with reference to the accompanying drawings. In the following description, well-known functions or constructions are not described in detail since they would obscure the invention in unnecessary detail.

The present disclosure relates to an apparatus and method for determining a high or low speed movement of a terminal and, according to the determination result, performing accurate frequency offset estimation in a broadband wireless access system. Below, the present disclosure provides a technology for determining a high speed or low speed movement of a terminal and, according to the determination result, applying a suitable frequency offset estimation scheme in a broadband wireless access system. For the sake of description's convenience, the present disclosure uses terms and names defined in an Institute of Electrical and Electronics Engineers (IEEE) 802.16m standard. However, the present disclosure is not limited by the terms and titles, and is identically applicable to a system employing an Orthogonal Frequency Division Multiplexing/Orthogonal Frequency Division Multiple Access (OFDM/OFDMA) scheme.

A system according to an exemplary embodiment of the present disclosure manages a FeedBack CHannel (FBCH) through which a BS acquires feedback information such as channel quality information of terminals, preferential band information, event occurrence information and the like. For example, a structure of the FBCH is illustrated in FIG. 1. FIG. 1 illustrates the structure of the FBCH in a broadband wireless access system according to an exemplary embodiment of the present disclosure. Referring to FIG. 1, the FBCH includes three Feedback Mini Tiles (FMTs), and one FMT occupies six symbols at time axis and two subcarriers at frequency axis. Through the FBCH, a sequence selected from a set of orthogonal or quasi-orthogonal sequences is transmitted from a terminal. The sequence has a length of ‘12’, and is repeatedly transmitted through the three FMTs. At this time, order of sequence elements can be different at each FMT.

As described above, a terminal transmits one sequence through the FBCH in a set of orthogonal or quasi-orthogonal sequences. According to this, the BS detects which sequence each terminal has transmitted through correlation operation, and acquires feedback information from the detected sequence. The FBCH can be used as a Primary-FBCH (PFBCH) and a Secondary-FBCH (SFBCH). The channel has the same structure, but can be the PFBCH or SFBCH according to a characteristic of the transmitted sequence. The PFBCH has a robust characteristic compared to the SFBCH, and the SFBCH has a great information amount compared to the PFBCH. Accordingly, a terminal moving at high speed is allocated the PFBCH.

A system according to an exemplary embodiment of the present disclosure manages all terminals in a low speed mode or a high speed mode. If erasure occurs continuously in an FBCH of a terminal that is in the low speed mode, a BS controls to increase a transmit power of the terminal. Although the BS increases the transmit power of the terminal, if the erasure occurs continuously, it will be suspected that the terminal is in high-speed movement. The erasure is a flag for warning that the reliability of FBCH detection is low. That is, the occurrence of the erasure means a failure of the FBCH detection. The FBCH detection is carried out through correlation operation of FBCH sequences and a received sequence. In an example where a correlation value of an FBCH sequence of a specific index is remarkably greater than correlation values of the remnant FBCH sequences, it is determined that the FBCH detection is reliable. In this example, the BS classifies the terminal as the high speed mode, and applies a frequency offset estimation technique for high speed movement. By this, even when the terminal moves at high speed, the system can maintain a communication quality, by compensating for a Doppler frequency and performing channel estimation. Also, the BS continuously observes a state of the terminal managed in the high speed mode and, if it is determined that the terminal does not need to be managed in the high speed mode, the BS again classifies the corresponding terminal as the low speed mode.

Prior to describing a classification of a high speed mode and a low speed mode, a frequency offset estimation technique in each mode is described as follows.

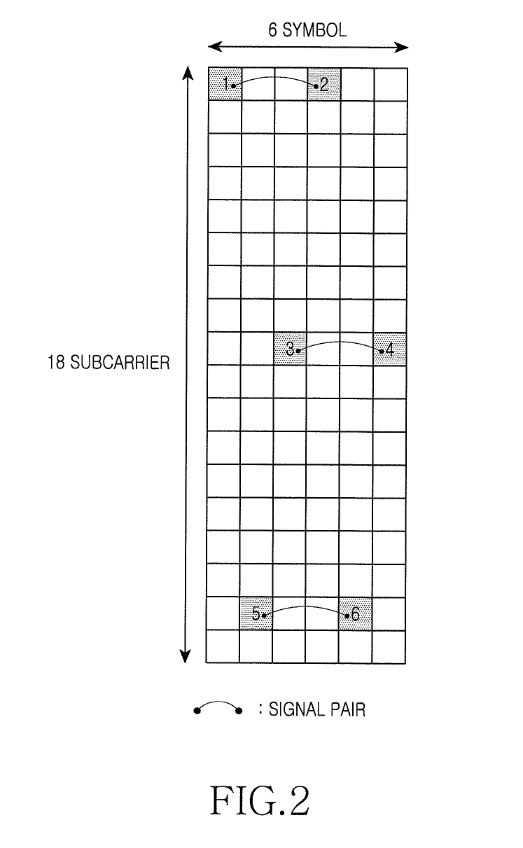

In an example embodiment of the low speed mode, pilot Frequency Offset Estimation (FOE) is applied. According to the pilot FOE, a frequency offset is estimated from a phase difference caused by a time difference of pilot signals. At this time, pilot signals of a stream of a corresponding terminal are used in all Physical Resource Units (PRUs) allocated to the terminal. For instance, a structure of the PRU is illustrated in FIG. 2. FIG. 2 illustrates a pilot signal pair for frequency offset estimation in a broadband wireless access system according to an exemplary embodiment of the present disclosure. Referring to FIG. 2, a Contiguous Resource Unit (CRU) occupies six symbols at time axis and eighteen subcarriers at frequency axis, and pilot signals are inserted in three subcarriers at an interval of 3 symbols. Among the pilot signals illustrated in FIG. 2, pilot signals located in the same subcarrier are paired, and a frequency offset is estimated through correlation operation for each pair. That is, Pilot#1 and Pilot#2 are paired, Pilot#3 and Pilot#4 are paired, and Pilot#5 and Pilot#6 are paired. The accumulation of correlation values between the pilot signals of the each pair is given as in Equation 1 below.

$${Z}_{pilot}^{r , u} = {\sum }_{n = 1}^{{PRU}^{{user ' s}^{uth}}} {\sum }_{i = 1}^{{N}_{p} / 2} {\hat{H}}_{LS}^{n , r} [ {l}_{2 i}^{p} , {k}_{2 i}^{p} ] {( {\hat{H}}_{LS}^{n , r} [ {l}_{2 i - 1}^{p} , {k}_{2 i - 1}^{p} ] )}^{*} \qquad ( 1 )$$

In Equation 1 above, the ‘Zₚᵢₗₒₜ^{r,u}’ represents an accumulated correlation value between pilot signals received through a receive antenna (r) from a user (u), the ‘Nₚ’ represents the number of pilot signals included in one PRU, the ‘Ĥ_{LS}^{n,r}’ represents a Least-Square (LS) channel estimation value of a pilot signal received through the receive antenna (r) from the user (u), the ‘l₂ᵢ^{p}’ represents a symbol index of a tone to which a pilot signal of an index (2i) is mapped, and the ‘k₂ᵢ^{p}’ represents a subcarrier index of the tone to which the pilot signal of the index (2i) is mapped.

And, a phase difference is decided from the correlation value as in Equation 2 below.

$${θ}_{pilot}^{r , u} = \frac{{∠Z}_{pilot}^{r , u}}{Δ l} \qquad ( 2 )$$

In Equation 2 above, the ‘θₚᵢₗₒₜ^{r, u}’ represents an accumulated phase difference between pilot signals received a receive antenna (r) from a user (u), the ‘Zₚᵢₗₒₜ^{r,u}’ represents an accumulated correlation value between the pilot signals received through the receive antenna (r) from the user (u), and the ‘Δl’ represents an interval between the pilot signals.

The phase difference decided as above is a value expressing a frequency offset at time axis. Accordingly, the phase difference value can convert into a frequency offset value. However, the phase difference value can, without converting into the frequency offset value, be used. For instance, in an example where estimation of the frequency offset is for compensation of a channel value, the phase difference value can be directly used for channel compensation. That is, the phase difference is one form of expressing the frequency offset. The phase difference and the frequency offset have the substantially same meaning.

In an example embodiment of the high speed mode, pilot FOE and PFBCH detection based FOE are applied. That is, for the sake of performance improvement of frequency offset estimation, a final frequency offset is estimated using all of a pilot FOE result and a PFBCH detection based FOE result. At this time, the pilot FOE is performed identically to the embodiment of the low speed mode. The PFBCH detection based FOE is performed as follows.

In an example where a terminal moves at high speed, PFBCH detection performance is deteriorated due to a Doppler frequency. Accordingly, if a frequency offset is estimated using a PFBCH sequence having a detection error, i.e., a PFBCH sequence erroneously detected, an estimation value different from that of a real frequency offset can be obtained. That is, when a frequency offset is estimated using a detected PFBCH sequence, PFBCH detection performance greatly affects frequency offset estimation performance. Accordingly, a PFBCH detection scheme having excellent performance even at high speed is demanded at the time of estimating a frequency offset of a terminal moving at high speed. According to this, a system according to an exemplary embodiment of the present disclosure detects a PFBCH using Extended PFBCH (EPFBCH) sequences. The EPFBCH sequences mean including a default PFBCH sequence and a PFBCH sequence transformed assuming a constant frequency offset. The EPFBCH sequences can be generated as in Equation 3 below.

$${C}_{t , k}^{( s )} = {C}_{t , k} exp [ - j2π ⌊ \frac{k}{2} ⌋ s {ɛ}_{MAX} ] \qquad ( 3 )$$

In Equation 3 above, the ‘k’ represents an index of a signal constituting a PFBCH sequence, the ‘t’ represents an FMT index, the ‘s’, which is an EPFBCH sequence set index, is set to one of ‘−1’, ‘0’, and ‘1’, the ‘C_{t,k}^{(s)}’ is a k^{th} signal constituting an EPFBCH sequence based on the index (s) in a t^{th} FMT, the ‘C_{t,k}’ represents a k^{th} signal constituting a default PFBCH sequence in the t^{th} FMT, and the ‘ε_{MAX}’, which is a normalized frequency of an EPFBCH sequence set, represents a variable of deciding a frequency offset region that an extended sequence intends to improve.

As shown in Equation 3 above, the EPFBCH sequences are extended by the index (s). In an example where the ‘s’ is equal to ‘0’, it represents a default sequence, and in an example where the ‘s’ is equal to ‘1’ or ‘−1’, it represents a transformed sequence. For instance, in an example where the number of default PFBCH sequences is equal to ‘64’, the total ‘192’ number of EPFBCH sequences are used for PFBCH sequence detection through the extension of Equation 3 above. Through this, even a PFBCH of a terminal moving at high speed can be detected accurately.

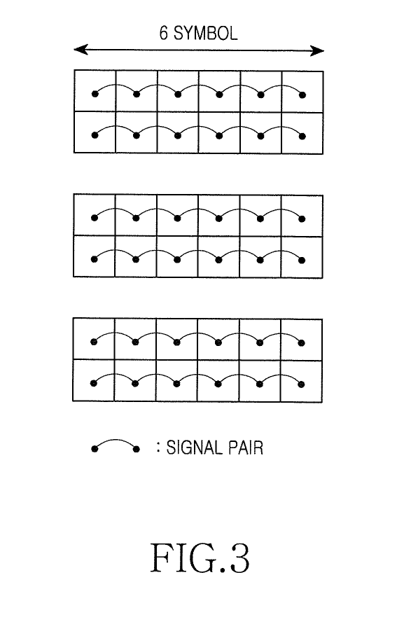

If a PFBCH sequence index is detected, a BS estimates a frequency offset with adopting, as virtual pilot signals, sequence elements corresponding to the detected index, i.e., signals constituting a PFBCH sequence. At this time, the virtual pilot signals are selected in pair as in FIG. 3. FIG. 3 illustrates a virtual pilot signal pair for frequency offset estimation in a broadband wireless access system according to an exemplary embodiment of the present disclosure. Referring to FIG. 3, the virtual pilot signal, i.e., the sequence element exists for every symbol. In other words, signals constituting a PFBCH sequence are arranged at a narrower interval than pilot signals, so providing a wider frequency offset estimation range than the pilot signals. In the example embodiments illustrated in FIG. 3, the accumulation of correlation values between signals constituting a PFBCH sequence is given as in Equation 4 below.

$${Z}_{PFBCH}^{u} = {\sum }_{k = 0}^{6} {\sum }_{l = 1}^{5} {{Y}_{l , k}^{u , r} ( {C}_{l , k}^{u} )}^{*} {( {Y}_{l - 1 , k}^{u , r} )}^{*} {C}_{l - 1 , k}^{u} \qquad ( 4 )$$

In Equation 4 above, the ‘Z_{PFBCH}^{u}’ represents an accumulated correlation value between signals constituting a PFBCH sequence of a user (u), the ‘l’ represents a symbol index, the ‘k’ represents a subcarrier index, the ‘Y_{l,k}^{u,r}’ represents a receive signal of a symbol (l) and symbol (k) position among PFBCH signals of a user (u) received through a receive antenna (r), and the ‘C_{l,k}^{u}’ represents a signal of the symbol (l) and symbol (k) position among the PFBCH signals of the user (u).

And, a phase difference is decided from the correlation value as in Equation 5 below.

θ_{PFBCH}^{r,u}=<Z_{PFBCH}^{r,u} (5)

In Equation 5 above, the ‘θ_{PFBCH}^{r, u}’represents an accumulated phase difference between signals constituting the PFBCH sequence received through the receive antenna (r) from the user (u), and the ‘Z_{PFBCH}^{r, u}’ represents the accumulated correlation value between the signals constituting the PFBCH sequence received through the receive antenna (r) from the user (u).

Whether a pilot FOE result has been out of an estimation range is determined using a phase difference decided according to the pilot FOE and a phase difference decided according to the FBCH detection based FOE. An indicator indicating whether the pilot FOE result has been out of the estimation range is decided as in Equation 6 below.

$${v}^{r , u} = round ( ( {θ}_{PFBCH}^{r , u} - {θ}_{Pilot}^{r , u} ) \frac{Δ l}{2 π} ) \qquad ( 6 )$$

In Equation 6 above, the ‘v^{r,u}’ represents an indicator indicating whether the pilot FOE result has been out of the estimation range in the receive antenna (r) for the user (u), the ‘round( )’ represents a round-off operator, the ‘θ_{PFBCH}^{r,u}’ represents the accumulated phase difference between the signals constituting the PFBCH sequence received through the receive antenna (r) from the user (u), the ‘θ_{Pilot}^{r,u}’ represents an accumulated phase difference between pilot signals received through the receive antenna (r) from the user (u), and the ‘Δl’ represents an interval between the pilot signals.

A final frequency offset is decided using the indicator as in Equation 7 below.

$${θ}_{freq}^{r , u} = {θ}_{Pilot}^{r , u} + {v}^{r , u} \frac{2 π}{Δ l} \qquad ( 7 )$$

In Equation 7 above, the ‘θ_{freq}^{r,u}’ represents a phase difference corresponding to the final frequency offset in the receive antenna (r) for the user (u), the ‘θ_{Pilot}^{r,u}’ represents the accumulated phase difference between the pilot signals received through the receive antenna (r) from the user (u), the ‘v^{r,u}’ represents an indicator indicating whether the pilot FOE result has been out of the estimation range in the receive antenna (r) for the user (u), and the ‘Δl’ represents the interval between the pilot signals.

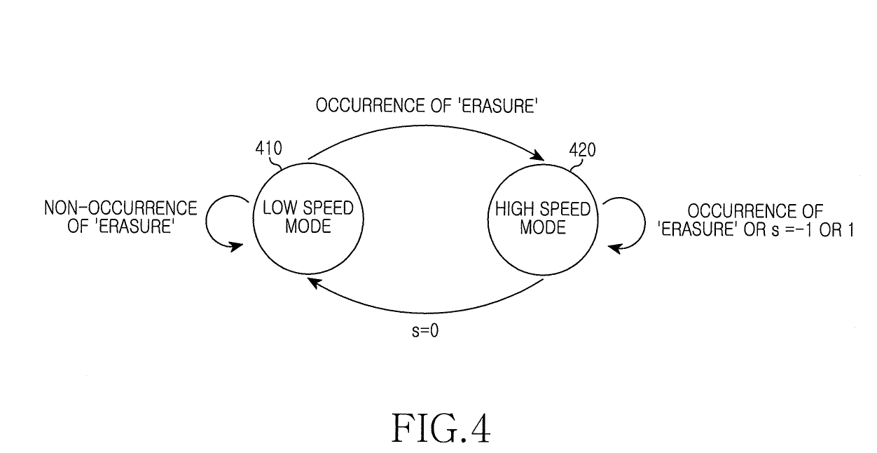

A system according to an exemplary embodiment of the present disclosure applies pilot FOE to a terminal classified as a low speed mode, and applies a technique of a combination of pilot FOE and FBCH detection based FOE to a terminal classified as a high speed mode. Prior to estimating a frequency offset as above, a BS has to classify each terminal as the low speed mode or the high speed mode. The mode of the terminal can be changed as illustrated in FIG. 4 below.

FIG. 4 illustrates a state transition diagram in a broadband wireless access system according to an exemplary embodiment of the present disclosure.

Referring to FIG. 4, a terminal is classified as a low speed mode (410) or a high speed mode (420). The terminal is firstly classified as the low speed mode (410) and, unless ‘Erasure’ does not occur, maintains the low speed mode (410). If the ‘Erasure’ occurs at N₁ times or more in a state where the terminal is classified as the low speed mode (410), the terminal is classified as the high speed mode (420). After the terminal is classified as the high speed mode (420), if the ‘Erasure’ occurs, or, although the ‘Erasure’ does not occur, if PFBCH detection fails for an EPFBCH sequence in which an index (s) is equal to ‘0’, in other words, if the PFBCH detection succeeds only for an EPFBCH sequence in which the index (s) is equal to ‘−1’ or ‘1’, the terminal maintains the high speed mode (420). In a state where the terminal is classified as the high speed mode (420), if the ‘Erasure’ does not occur and the PFBCH detection succeeds continuously at N₂ times or more for the EPFBCH sequence in which the index (s) is equal to ‘0’, the terminal is classified as the low speed mode (410). The EPFBCH sequence in which the index (s) is equal to ‘0’ is a default PFBCH sequence not transformed. That the PFBCH detection succeeds for the default PFBCH sequence means that the influence of a Doppler frequency is less. This means that a movement speed is low. In the aforementioned mode change, the ‘N₁’ and the ‘N₂’ are integers equal to or greater than ‘1’, and can be the same or different from each other.

Operations and constructions of a BS for determining a mode of a terminal and, according to the determination result, selecting a corresponding frequency offset estimation technique as above are described below in detail with reference to the drawings.

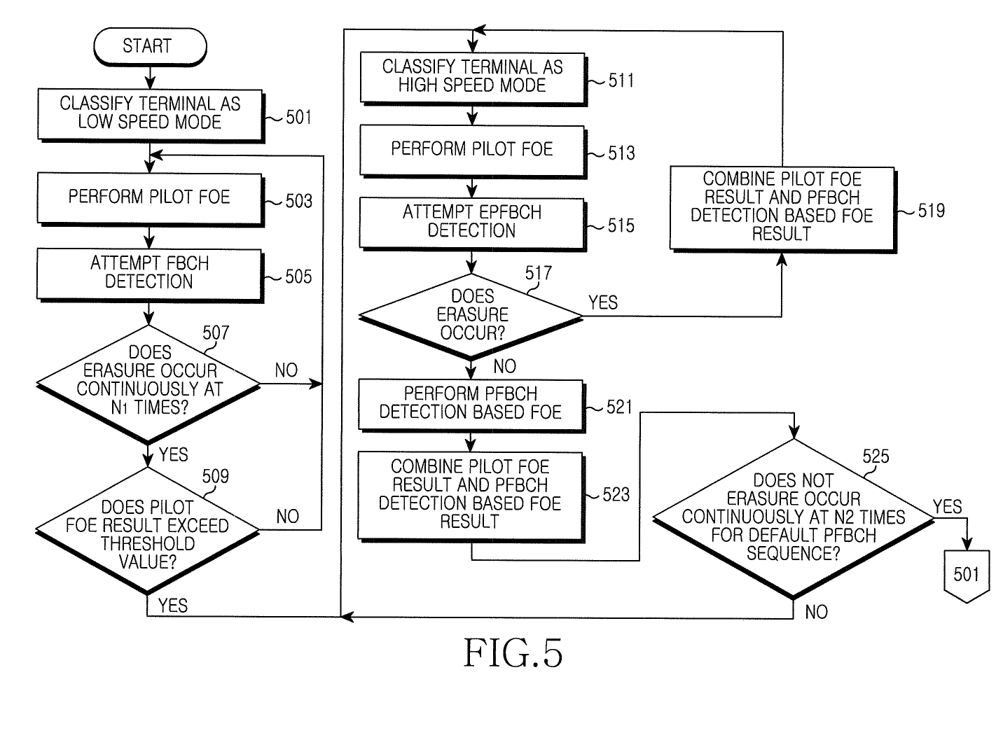

FIG. 5 illustrates an operation procedure of a BS in a broadband wireless access system according to an exemplary embodiment of the present disclosure.

Referring to FIG. 5, in step 501, the BS classifies a terminal as a low speed mode. That is, a terminal initially accessing the BS, i.e., a terminal having no information to determine a mode is classified as the low speed mode.

After that, the BS proceeds to step 503 and performs pilot FOE. In other words, the BS estimates a frequency offset using a pilot signal. In detail, the BS decides, as a pilot pair, adjacent pilot signals included in the same subcarrier among uplink pilot signals within a unit resource allocated to the terminal, calculates an accumulated phase difference of respective pilot pairs, and estimates a frequency offset from the accumulated phase difference. For example, the phase difference can be determined through correlation operation. For example, the phase difference can be decided as in Equation 1 and Equation 2 above.

After performing the pilot FOE, the BS proceeds to step 505 and attempts FBCH detection. That is, the BS performs correlation operation between each of FBCH sequence candidates and a signal sequence received through an FBCH. And, the BS determines that an FBCH sequence having the highest correlation value is a sequence transmitted from the terminal. Here, the FBCH can be a PFBCH or SFBCH.

After attempting the FBCH detection, the BS proceeds to step 507 and determines if erasure has occurred continuously at N₁ times. That the erasure occurs means a situation in which the FBCH detection is not reliable because a correlation value of an FBCH sequence of a specific index is not noticeably greater than correlation values of the remnant FBCH sequences. In other words, the occurrence of the erasure means a failure of the FBCH detection. In contrast, the non-occurrence of the erasure means a success of the FBCH detection. For instance, it can be defined that the erasure occurs in at least once among an example where a maximum correlation value to average value cannot exceed a threshold value, an example where there is at least one correlation value having a difference equal to or less than the threshold value with a maximum correlation value, and an example where the maximum correlation value is equal to or less than the threshold value. If the erasure does not occur continuously at the N₁ times, the BS keeps the terminal in the low speed mode, and returns to step 503.

In contrast, if it is determined in step 507 that the erasure occurs continuously at the N₁ times, the BS proceeds to step 509 and determines if a pilot FOE result exceeds the threshold value. In other words, the BS determines if an absolute value of a frequency offset of the terminal exceeds the threshold value. The threshold value means a reference frequency offset value classified as a high speed mode. If it is determined in step 509 that the pilot FOE result does not exceed the threshold value, the BS keeps the terminal in the low speed mode, and returns to step 503.

In contrast, if it is determined in step 509 that the pilot FOE result exceeds the threshold value, the BS proceeds to step 511 and classifies the terminal as the high speed mode. That is, if the erasure occurs continuously at the N₁ times and the pilot FOE result exceeds the threshold value, the corresponding terminal is classified as the high speed mode. According to this, the terminal applies not only pilot FOE but also PFBCH detection based FOE.

Next, the BS proceeds to step 513 and performs pilot FOE. In other words, the BS estimates a frequency offset using a pilot signal. In detail, the BS decides, as a pilot pair, adjacent pilot signals included in the same subcarrier among uplink pilot signals within a unit resource allocated to the terminal, calculates an accumulated phase difference of respective pilot pairs, and estimates a frequency offset from the accumulated phase difference. For instance, the phase difference can be determined through correlation operation. For instance, the phase difference can be decided as in Equation 1 and Equation 2 above.

After that, the BS proceeds to step 515 and attempts EPFBCH detection. In other words, the BS attempts PFBCH detection, but attempts the PFBCH detection using an EPFBCH sequence. In detail, the BS extends PFBCH sequence candidates by transforming PFBCH sequences. For example, the BS can extend the PFBCH sequence candidates as in Equation 3 above. And, the BS performs correlation operation between each of the EPFBCH sequences and a signal sequence received through a PFBCH. And, the BS determines that an FBCH sequence having the highest correlation value is a sequence transmitted from the terminal.

After attempting the EPFBCH detection, the BS proceeds to step 517 and determines if erasure has occurred. That the erasure occurs means a situation in which the FBCH detection is not reliable because a correlation value of an FBCH sequence of a specific index is not noticeably greater than correlation values of the remnant FBCH sequences. For instance, it can be defined that the erasure occurs in at least once among an example where a maximum correlation value to average value cannot exceed a threshold value, an example where there is at least one correlation value having a difference equal to or less than the threshold value with a maximum correlation value, and an example where the maximum correlation value is equal to or less than the threshold value.

If it is determined in step 517 that the erasure occurs, the BS proceeds to step 519 and combines the frequency offset estimated through the pilot FOE in step 513 and a frequency offset previously estimated through PFBCH detection based FOE. That is, that the erasure occurs means that a current EPFBCH detection result is not reliable. This means that the PFBCH detection based FOE is not reliable too. Accordingly, the BS uses a frequency offset estimated through PFBCH detection based FOE that has been performed at a previous time point at which erasure does not occur. In detail, the BS decides an indicator indicating if the pilot FOE result has been out of an estimation range, using the frequency offset estimated through the PFBCH detection based FOE and the frequency offset estimated through the pilot FOE. For example, the indicator can be decided as in Equation 6 above. By correcting the pilot FOE result depending on the indicator, the BS decides a final frequency offset. For example, the final frequency offset can be decided as in Equation 7 above. However, if the frequency offset previously estimated through the PFBCH detection based FOE does not exist, step 519 can be omitted.

In contrast, if it is determined in step 517 that the erasure does not occur, the BS proceeds to step 521 and performs PFBCH detection based FOE. That is, the BS performs FOE with adopting, as a virtual pilot signal, an EPFBCH sequence detected in step 515. In detail, the BS decides, as a signal pair, adjacent signals included in the same subcarrier among signals constituting the PFBCH sequence, calculates an accumulated phase difference of respective signal pairs, and estimates a frequency offset from the accumulated phase difference. For instance, the phase difference can be determined through correlation operation. For instance, the phase difference can be decided as in Equation 4 and Equation 5 above.

Next, the BS proceeds to step 523 and combines the frequency offset estimated through the pilot FOE in step 513 and the frequency offset estimated through the PFBCH detection based FOE in step 521. In detail, the BS decides an indicator indicating whether a pilot FOE result has been out of an estimation range, using the frequency offset estimated through the PFBCH detection based FOE and the frequency offset estimated through the pilot FOE. For example, the indicator can be decided as in Equation 6 above. By correcting the pilot FOE result according to the indicator, the BS decides a final frequency offset. For example, the final frequency offset can be decided as in Equation 7 above.

After that, the BS proceeds to step 525 and determines if erasure has not occurred continuously at N₂ times for a default PFBCH sequence. In other words, the BS determines if PFBCH detection succeeds continuously at the N₂ times for the default PFBCH sequence. Here, the default PFBCH sequence means a PFBCH sequence belonging to a non-extended PFBCH sequence. In other words, the default PFBCH sequence means a sequence in which an index (s) is equal to ‘0’ in Equation 3 above. If it is determined in step 525 that the erasure does not occur continuously at the N₂ times for the default PFBCH sequence, the BS returns to step 501 and classifies the terminal as the low speed mode. That is, that PFBCH detection succeeds for the default PFBCH sequence means that the influence of a Doppler frequency is less, so the terminal is classified as the low speed mode. In contrast, if at least one erasure has occurred during the EPFBCH detection attempt of N₂ times, the BS keeps the terminal in the high speed mode, and returns to step 511.

Although not illustrated in FIG. 5, the BS can compensate for a channel estimation value using a frequency offset estimated in step 503, step 518, and step 523, and equalize a distortion of a data signal using the compensated channel estimation value.

In FIG. 5, the pilot FOE can be performed at a period of frame or subframe. In this example, steps using a pilot signal, i.e., step 503, step 509, step 513, step 519, and step 523 can be omitted if traffic is not allocated to a corresponding terminal in a specific frame or specific subframe.

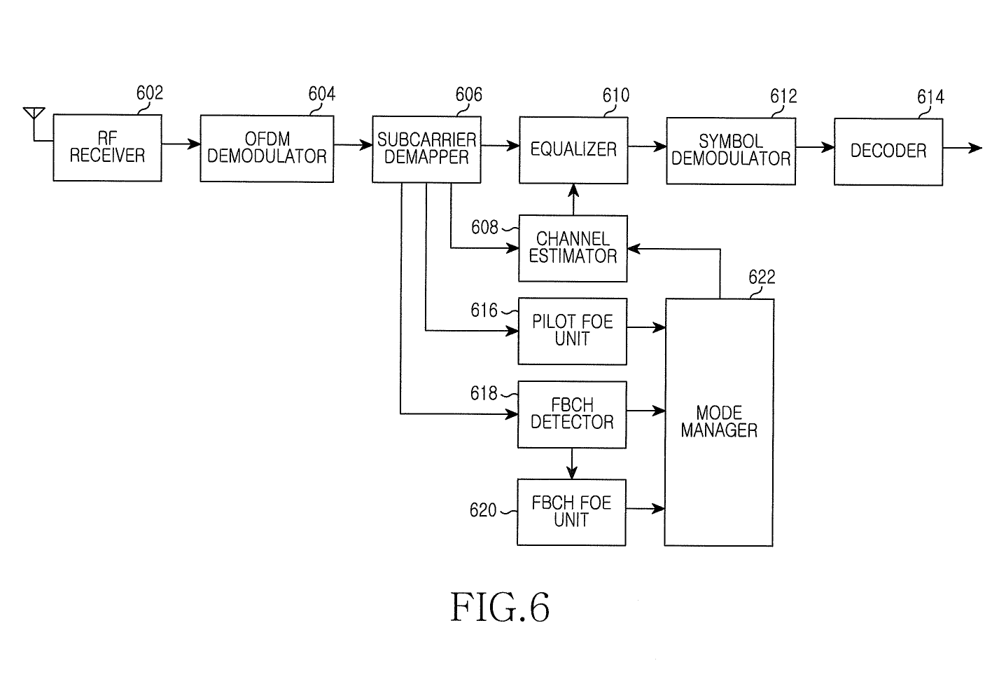

FIG. 6 illustrates a construction of a BS in a broadband wireless access system according to an exemplary embodiment of the present disclosure.

As illustrated in FIG. 6, the BS includes a Radio Frequency (RF) receiver 602, an OFDM demodulator 604, a subcarrier demapper 606, a channel estimator 608, an equalizer 610, a symbol demodulator 612, a decoder 614, a pilot FOE unit 616, an FBCH detector 618, an FBCH FOE unit 620, and a mode manager 622.

The RF receiver 602 down converts an RF band signal received through an antenna into a baseband signal. The OFDM demodulator 604 distinguishes the signals provided from the RF receiver 602 in a unit of OFDM symbol and then, restores complex symbols mapped to a frequency domain through Fast Fourier Transform (FFT) operation. The subcarrier demapper 606 classifies the complex symbols mapped to the frequency domain in a unit of processing. For example, the subcarrier demapper 606 provides data signals to the equalizer 610, provides pilot signals to the channel estimator 608 and the pilot FOE unit 616, and provides signals received through an FBCH to the FBCH detector 618 and the FBCH FOE unit 620.

The channel estimator 608 estimates a channel with a terminal having transmitted pilot signals, using the pilot signals provided from the subcarrier demapper 606. Also, the channel estimator 608 compensates for a channel estimation value using a frequency offset provided from the mode manager 622. And, the channel estimator 608 provides the channel estimation value to the equalizer 610. The equalizer 610 compensates for a distortion of a data signal using the channel estimation value provided from the channel estimator 608. The symbol demodulator 612 converts complex symbols into a bit stream by demodulating the complex symbols. The decoder 614 restores an information bit stream by channel decoding the bit stream.

The pilot FOE unit 616 performs pilot FOE. In other words, the pilot FOE unit 616 estimates a frequency offset using pilot signals provided from the subcarrier demapper 606. In detail, the pilot FOE unit 616 decides, as a pilot pair, adjacent pilot signals included in the same subcarrier among uplink pilot signals within a unit resource allocated to a corresponding terminal, calculates an accumulated phase difference of respective pilot pairs, and estimates a frequency offset from the accumulated phase difference. For example, the phase difference can be determined through correlation operation. For example, the phase difference can be decided as in Equation 1 and Equation 2 above.

The FBCH detector 618 detects an FBCH sequence that a corresponding terminal has transmitted, using a signal received through an FBCH. Here, the FBCH sequence includes a PFBCH sequence and an SFBCH sequence. That is, the FBCH detector 618 performs correlation operation between each of FBCH sequence candidates and a signal sequence received through the FBCH, and determines that an FBCH sequence having the highest correlation value is a sequence transmitted from the corresponding terminal. At this time, in an example where the corresponding terminal is classified as a high speed mode, the FBCH sequence candidates are extended into EFPBCH sequences. That is, the FBCH detector 618 extends PFBCH sequence candidates by transforming PFBCH sequences. For example, the FBCH detector 618 can extend the PFBCH sequence candidates as in Equation 3 above. And, the FBCH detector 618 determines the reliability of detection using the result of the correlation operation. In an example where a correlation value of an FBCH sequence of a specific index is not remarkably greater than correlation values of the remnant FBCH sequences, it is determined that the reliability of FBCH detection is low. For example, it can be defined that the reliability is low at least once among an example where a maximum correlation value to average value cannot exceed a threshold value, an example where there is at least one correlation value having a difference equal to or less than the threshold value with a maximum correlation value, and an example where the maximum correlation value is equal to or less than the threshold value.

The FBCH FOE unit 620 performs FBCH detection based FOE. In other words, the FBCH FOE unit 620 performs FOE with adopting, as a virtual pilot signal, an EPFBCH sequence detected by the FBCH detector 618. In detail, the FBCH FOE unit 620 decides, as a signal pair, adjacent signals included in the same subcarrier among signals constituting the PFBCH sequence, calculates an accumulated phase difference of respective signal pairs, and estimates a frequency offset from the accumulated phase difference. For example, the phase difference can be determined through correlation operation. For example, the phase difference can be decided as in Equation 4 and Equation 5 above.

The mode manager 622 decides a mode of a terminal using a pilot FOE result of the pilot FOE unit 616, an FBCH detection result of the FBCH detector 618, and an FBCH detection based FOE result of the FBCH FOE unit 620, and decides a final frequency offset according to an FOE technique corresponding to a mode. An operation of the mode manager 622 is described below in detail.

The mode manager 622 may only apply pilot FOE to a terminal classified as a low speed mode and estimates a frequency offset. An initially accessed terminal is classified as the low speed mode. For FBCH detection of the terminal classified as the low speed mode, if erasure occurs continuously at N₁ times and simultaneously, the pilot FOE result of the terminal exceeds a threshold value, the mode manager 622 classifies the terminal as a high speed mode. Here, the occurrence or non-occurrence of the erasure is determined according to a notification of the detection reliability of the FBCH detector 618.

The mode manager 622 applies pilot FOE and PFBCH detection based FOE to a terminal classified as a high speed mode, combines the pilot FOE result and the FBCH detection based FOE result, and decides a frequency offset of the terminal. In detail, the mode manager 622 decides an indicator indicating whether the pilot FOE result has been out of an estimation range, using a frequency offset estimated through the PFBCH based FOE and a frequency offset estimated through the pilot FOE, and decides a final frequency offset by correcting the pilot FOE result according to the indicator. While the terminal is managed in the high speed mode, EPFBCH detection can fail. In this example, the mode manager 622 combines the FOE results using a frequency offset estimated through PFBCH detection based FOE that have been performed at a previous time point at which erasure does not occur. If erasure does not occur continuously at N₂ times for EPFBCH detection of a terminal classified as a high speed mode, the mode manager 622 classifies the terminal as the low speed mode.

The pilot FOE can be performed at a period of frame or subframe. In this example, functions using a pilot signal (i.e., pilot FOE, an operation of comparing the pilot FOE result with a threshold value, and an operation of combining the pilot FOE result and the PFBCH detection based FOE result) can be omitted if traffic is not allocated to a corresponding terminal in a specific frame or specific subframe.

As described above, exemplary embodiments of the present disclosure can minimize an operation amount of frequency offset estimation and effectively estimate a frequency offset, by classifying a terminal as a high speed mode or a low speed mode using a success or failure of FBCH detection and, according to the classification result, selectively applying a frequency offset estimation technique in a broadband wireless access system.

While the invention has been shown and described with reference to certain preferred embodiments thereof, it will be understood by those skilled in the art that various changes in form and details may be made therein without departing from the spirit and scope of the invention as defined by the appended claims.

What is claimed is:

1. An operation method of a base station (BS) in a wireless access system, the method comprising:
performing feedback channel detection for a terminal classified as a low speed mode; and
if the feedback channel detection fails a predefined number of times and a frequency offset estimation result using a pilot signal exceeds a threshold value, classifying the terminal as a high speed mode.

2. The method of claim 1 further comprising:
performing the feedback channel detection using default sequences and sequences extended from the default sequences for the terminal classified as the high speed mode; and
if the feedback channel detection succeeds for the default sequences the predefined number of times, classifying the terminal as the low speed mode.

3. The method of claim 2 further comprising:
classifying an initially accessed terminal as the low speed mode.

4. The method of claim 2 further comprising:
performing frequency offset estimation using the pilot signal for the terminal classified as the low speed mode; and
identifying the frequency offset estimation result using the pilot signal as a final frequency offset estimation result.

5. The method of claim 2, further comprising:
performing frequency offset estimation using the pilot signal for the terminal classified as the high speed mode; and
identifying a final frequency offset by combining the frequency offset estimation result using the pilot signal and a frequency offset estimation result using a sequence.

6. The method of claim 5, wherein deciding the final frequency offset comprises:
if the feedback channel detection using the sequences extended from the default sequences succeeds, estimating a frequency offset using a detected sequence; and
combining a frequency offset estimation result using the detected sequence and the frequency offset estimation result using the pilot signal.

7. The method of claim 5, wherein identifying the final frequency offset comprises:
combining a frequency offset estimation result using a previously detected sequence and the frequency offset estimation result using the pilot signal.

8. The method of claim 2, wherein performing the feedback channel detection using the default sequences and the sequences extended from the default sequences comprises:
generating the sequences extended from the default sequences; and
performing a correlation operation between each of the default sequences and a signal sequence received through a feedback channel.

9. An apparatus in base station (BS) in a wireless access system, the apparatus comprising:
a detector configured to perform feedback channel detection for a terminal classified as a low speed mode; and
a mode manager configured to, if the feedback channel detection fails a predefined number of times and a frequency offset estimation result using a pilot signal exceeds a threshold value, classify the terminal as a high speed mode.

10. The apparatus of claim 9, wherein:
the detector is further configured to perform the feedback channel detection using default sequences and sequences extended from the default sequences for the terminal classified as the high speed mode, and
the mode manager is further configured to classify the terminal as the low speed mode if the feedback channel detection succeeds for the default sequences the predefined number of times.

11. The apparatus of claim 10, wherein the mode manager is further configured to classify an initially accessed terminal as the low speed mode.

12. The apparatus of claim 10 further comprising:
an offset estimator configured to perform frequency offset estimation using the pilot signal for the terminal classified as the low speed mode,
wherein the mode manager is further configured to identify the frequency offset estimation result using the pilot signal as a final frequency offset estimation result.

13. The apparatus of claim 10 further comprising:
an offset estimator configured to perform frequency offset estimation using the pilot signal for the terminal classified as the high speed mode,
wherein the mode manager is further configured to identify a final frequency offset by combining the frequency offset estimation result using the pilot signal and a frequency offset estimation result using a sequence.

14. The apparatus of claim 13, wherein:
if the feedback channel detection using the sequences extended from the default sequences succeeds, the offset estimator is further configured to estimate a frequency offset using a detected sequence, and
the mode manager is further configured to combine a frequency offset estimation result using the detected sequence and the frequency offset estimation result using the pilot signal.

15. The apparatus of claim 13, wherein if the feedback channel detection using the sequences extended from the default sequences fails, the mode manager is further configured to combine a frequency offset estimation result using a previously detected sequence and the frequency offset estimation result using the pilot signal.

16. The apparatus of claim 10, wherein the detector is further configured to generate the sequences extended from the default sequences, and perform a correlation operation between each of the default sequences and a signal sequence received through a feedback channel.

17. A wireless access system comprising a plurality of base stations (BSs), at least one base station in the plurality of BSs comprising:
a detector configured to perform feedback channel detection for a terminal classified as a low speed mode; and
a mode manager configured to, if the feedback channel detection fails a predefined number of times and a frequency offset estimation result using a pilot signal exceeds a threshold value, classify the terminal as a high speed mode.

18. The system of claim 17, wherein:
the detector is further configured to perform the feedback channel detection using default sequences and sequences extended from the default sequences for the terminal classified as the high speed mode, and
the mode manager is further configured to classify the terminal as the low speed mode if the feedback channel detection succeeds for the default sequences the predefined number of times.

19. The system of claim 18, wherein the mode manager is further configured to classify an initially accessed terminal as the low speed mode.

20. The system of claim 18, wherein the at least one base station further comprises:
an offset estimator configured to perform frequency offset estimation using the pilot signal for the terminal classified as the low speed mode,
wherein the mode manager is further configured to identify the frequency offset estimation result using the pilot signal as a final frequency offset estimation result.
